(19) United States
(12) Patent Application Publication
(10) Pub. No.: US 2022/0012601 A1
(43) Pub. Date: Jan. 13, 2022

(54) APPARATUS AND METHOD FOR HYPERPARAMETER OPTIMIZATION OF A MACHINE LEARNING MODEL IN A FEDERATED LEARNING SYSTEM

(71) Applicant: Huawei Technologies Co., Ltd., Shenzhen (CN)

(72) Inventors: Muhammad AMAD-UD-DIN, Kista (SE); Adrian FLANAGAN, Helsinki (FI); Kuan Eeik TAN, Helsinki (FI); Elena IVANNIKOVA, Helsinki (FI); Qiang FU, Helsinki (FI)

(21) Appl. No.: 17/484,886

(22) Filed: Sep. 24, 2021

Related U.S. Application Data
(63) Continuation of application No. PCT/EP2019/057597, filed on Mar. 26, 2019.

(51) Int. Cl. G06N 5/02; G06N 5/00

(52) U.S. Cl. CPC G06N 5/022; G06N 5/003

(57) ABSTRACT

A Federated learning server and a method are provided. The Federated learning server is configured to aggregate a plurality of received model updates to update a master machine learning model. Once a pre-defined threshold or interval for received model updates is reached, a set of current hyper-parameter values and corresponding validation set performance metrics obtained from the updated master machine learning model are sent to a hyper-parameter optimization model. The optimization model infers the next set of optimal hyper-parameters using pairwise history of hyper-parameter values and the corresponding performance metrics. The inferred hyper-parameter values are sent to the Federated Learning server which updates the master machine learning model with the updated set of hyper-parameter values and redistributes the updated master machine learning model with the updated set of hyper-parameter values. According to the application, hyper-parameter optimization in a Federated learning mode can be realized to provide accurate personalized recommendations.

### CROSS-REFERENCE TO RELATED APPLICATIONS

This application is a continuation of International Application No. PCT/EP2019/057597, filed on Mar. 26, 2019, the disclosure of which is hereby incorporated by reference in its entirety.

### TECHNICAL FIELD

Embodiments of the present disclosure relate generally to Federated Learning Systems and Federated Recommendation Systems and more particularly to enhancing privacy of data in a Federated Learning or Recommendation System.

### BACKGROUND

Personalized recommendation applications requirements are typically based on three main aspects. First, the recommendation applications will typically require user data such as age, gender, location, watch or viewing history and other personal, private or confidential information. Second, the recommendation application needs a machine learning model to learn user preferences from this data. Third, the recommendation application requires hyper-parameter optimization for training a more robust and accurate machine learning model. The hyper-parameters represent the prior assumptions about the model structure and the underlying data generation process. The principle limitation of the traditional solution is that it needs access to the personal data and the model jointly, while evaluating the hyper-parameter configurations.

Correct hyper-parameter values are needed to improve the quality of recommendations which generally yields a better user experience. However, the typical personal recommendation system typically relies on transferring, storing and processing the clients or users' personal data in central servers. This approach becomes increasingly challenging to implement especially after implementation of the General Data Protection Regulation (GDPR). The Federated Learning model approach attempts to address the issues related to data access and privacy in a machine learning model. However, the data privacy issues related to hyper-parameter optimization, which requires access to user data, have not been adequately addressed.

Accordingly, it would be desirable to be able to provide a system that addresses at least some of the problems identified above.

### SUMMARY

It is an object of the disclosed embodiments to provide an apparatus and method that enhances privacy of hyper-parameter optimization in a Federated learning model. This object is solved by the subject matter of the independent claims. Further advantageous modifications can be found in the dependent claims.

According to a first aspect the above and further objects and advantages are obtained by a server apparatus. In one embodiment, the server apparatus includes a processor that is configured to aggregate a plurality of received model updates to update a master machine learning model; determine if a pre-defined threshold for received model updates is reached; transmit a set of current hyper-parameter values and corresponding validation set performance metrics obtained from the updated master machine learning model to a hyper-parameter optimization model; receive an updated set of hyper-parameter values from the hyper-parameter optimization model; update the master machine learning model with the updated set of hyper-parameter values; and redistribute the updated master machine learning model with the updated set of hyper-parameter values. The aspects of the disclosed embodiments provide for hyper-parameter optimization in a Federated learning mode to provide accurate personalized recommendations, for applications such as the Huawei video service.

In a first possible implementation form of the server apparatus according to the first aspect as such the processor is configured to periodically request an updated set of hyper-parameter values from the hyper-parameter optimization model. Using hyper-parameter optimization, the machine learning model can be tuned to yield better recommendations.

In a possible implementation form of the server apparatus the master machine learning model is operating in a Federated Learning System. The Federated Learning System supports maximizing the client's privacy.

In a possible implementation form of the server apparatus the master machine learning model is one or more of a Federated Learning Collaborative Filter model or a Federated Learning Logistic Regression Model. Hyper-parameter optimization in a Federated Learning mode enables providing more accurate personalized recommendations.

According to a second aspect the above and further objects and advantages are obtained by a server apparatus. In one embodiment, the server apparatus includes a processor that is configured to receive a set of current hyper-parameter values for a master machine learning model and corresponding validation set performance metrics from a federated learning server; determine an updated set of hyper-parameter values for the master machine learning model from the received set of hyper-parameter values and the corresponding validation set performance metrics; and send the updated set of hyper-parameter values for the master machine learning model to the federated learning server. The aspects of the disclosed embodiments provide for hyper-parameter optimization in a Federated learning mode to provide accurate personalized recommendations, for applications such as the Huawei video service.

In a possible implementation form of the server apparatus according to the second aspect as such the processor is configured to cause the server apparatus to maintain a pairwise history of received hyper-parameter values and corresponding validation set performance metrics obtained from the master machine learning model on the federated learning server. The aspects of the disclosed embodiments allows for adaptive tuning of the hyper-parameters while the Federated Learning model is being trained and does not rely on the repeated off-line testing of the hyper-parameter configurations. This continuous online tuning not only improves the accuracy of recommendations but also helps to achieve faster convergence thereby reducing the computational complexity.

In a possible implementation form of the server apparatus according to the second aspect as such, the processor is configured to train an optimization model using an accumulated history of hyper-parameter values and the corresponding validation set performance metrics. The aspects of the disclosed embodiments minimizes the overhead cost for data transfer, storage and security for the optimization of a machine learning model that is trained on big data inherently distributed across millions of clients for example mobile phones or hand held devices.

In a further possible mentation of the server apparatus according to the second aspect the processor is configured to cause the trained optimization model to infer the updated set of hyper-parameter values for the master machine learning model from the received hyper-parameter values and the corresponding validation set performance metrics. The aspects of the disclosed embodiments allow for adaptive tuning of the hyper-parameters while the Federated learning model is being trained and does not rely on the repeated off-line testing of the hyper-parameter configurations. This continuous online tuning not only improves the accuracy of recommendations but also helps to achieve faster convergence thereby reducing the computational complexity.

According to a third aspect the above and further objects and advantages are obtained by a method. In one embodiment, the method includes aggregating a plurality of received model updates to update a master machine learning model; determining if a pre-defined threshold for received model updates is reached; transmitting a set of current hyper-parameter values and corresponding validation set performance metrics obtained from the updated master machine learning model to a hyper-parameter optimization model; receiving an updated set of hyper-parameter values from the hyper-parameter optimization model; updating the master machine learning model with the updated set of hyper-parameter values; and redistributing the updated master machine learning model with the updated set of hyper-parameter values to a plurality of clients. The aspects of the disclosed embodiments provide for hyper-parameter optimization in a Federated learning mode to provide accurate personalized recommendations, for applications such as the Huawei video service.

In a possible implementation mode of the method according to the third aspect as such, the method includes periodically requesting an updated set of hyper-parameter values from the hyper-parameter optimization model. The aspects of the disclosed embodiments allow for adaptive tuning of the hyper-parameters while the Federated learning model is being trained and does not rely on the repeated off-line testing of the hyper-parameter configurations. This continuous online tuning not only improves the accuracy of recommendations but also helps to achieve faster convergence thereby reducing the computational complexity.

According to a fourth aspect the above and further objects and advantages are obtained by a method. In one embodiment, the method includes receiving a set of current hyper-parameter values for a master machine learning model and corresponding validation set performance metrics from a federated learning server; determining an updated set of hyper-parameter values for the master machine learning model from the received set of hyper-parameter values and the corresponding validation set performance metrics; and sending the updated set of hyper-parameter values for the master machine learning model to the federated learning server. The aspects of the disclosed embodiments maximizes the client's privacy. Access to the clients' personal data and the models is not required. The only information that is required from the clients, without knowing their identities, is the validation set performances, also termed as accuracy metrics.

In a possible implementation mode of the method according to the fourth aspect the method includes updating the master machine learning model with the updated set of hyper-parameter values, and redistributing the updated master machine learning model with the updated set of hyper-parameter values. The aspects of the disclosed embodiments enable optimizing hyper-parameters in an online continuously adaptive fashion, meanwhile the Federated learning master model continues the training

In a possible implementation mode of the method according to the fourth aspect, the method includes maintaining a dataset of a pairwise history of hyper-parameter values and validation set performance metrics; training an optimization model using the pairwise history; and determining an updated set of hyper-parameter values using the trained optimization model. This solution allows adaptive tuning of the hyper-parameters while the Federated Learning model is being trained and does not rely on the repeated off-line testing of the hyper-parameter configurations. This continuous online tuning not only improves the accuracy of recommendations but also helps to achieve faster convergence thereby reducing the computational complexity.

In a possible implementation mode of the method according to the fourth aspect the updated master machine learning model with the updated set of hyper-parameter values is redistributed to a plurality of clients subscribing to a video service. The aspects of the disclosed embodiments provide for hyper-parameter optimization in a Federated learning mode to provide accurate personalized recommendations, for applications such as the Huawei video service.

According to a fifth aspect the above and further objects and advantages are obtained by a non-transitory computer readable media having stored thereon program instructions. In one embodiment, the program instructions, when executed by a processor cause the processor to perform the method of the possible implementation forms. The aspects of the disclosed embodiments provide for hyper-parameter optimization in a Federated learning mode to provide accurate personalized recommendations, for applications such as the Huawei video service.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the invention will be explained in more detail with reference to the example embodiments shown in the drawings, in which:

FIG. 1 illustrates a schematic view of exemplary system incorporating aspects of the disclosed embodiments.

FIG. 2 illustrates a schematic view an exemplary Federated Learning system incorporating aspects of the disclosed embodiments.

FIG. 3 illustrates a schematic view of exemplary recommendation system incorporating aspects of the disclosed embodiments.

FIG. 4 illustrates an exemplary method incorporating aspects of the disclosed embodiments.

FIG. 5 illustrates an exemplary method incorporating aspects of the disclosed embodiments.

FIG. 6 illustrates an exemplary sequence diagram for a process incorporating aspects of the disclosed embodiments.

FIG. 7 illustrates a schematic of an exemplary apparatus that can be used to practice aspects of the disclosed embodiments.

### DETAILED DESCRIPTION OF THE DISCLOSED EMBODIMENTS

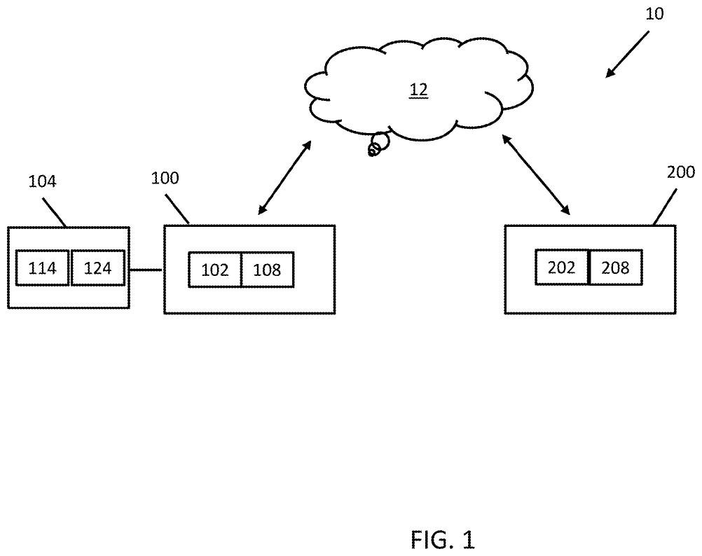

Referring to FIG. 1 an exemplary system 10 incorporating aspects of the disclosed embodiments is illustrated. The aspects of the disclosed embodiments are directed to a system 10 that performs hyper-parameter optimization in a Federated Learning (FL) system without compromising the personal user data that is typically required for hyper-parameter optimization in a personalized recommendation system. In accordance with the aspects of the disclosed embodiments, the hyper-parameter optimization in the personalized recommendation system uses historical data to predict the next set of potentially optimal or better hyper-parameter values. The hyper-parameter and corresponding optimization does not require access to the users' personal data or local models. Rather, all that is needed is the history of hyper-parameter values and the corresponding validation set performances obtained with those values.

As is illustrated in FIG. 1, in one embodiment the system 10 includes a server apparatus 100. In one embodiment, the server apparatus is a Federated Learning server for a Federated Learning (FL) model, an example of which is described in PCT/EP2017/084494 and PCT/EP2017/084491, the disclosures of which are incorporated herein by reference in their entireties. However, in order to generate refined and more accurate personalized recommendations, the Federated learning model require hyper-parameter optimization. The server apparatus 100 is configured to aggregate a plurality of received model updates to update a machine learning model. The aspects of the disclosed embodiments are configured to perform an adaptive hyper-parameter optimization in a Federated Learning Mode. Personal data is fully private and localized on the client devices 200. The machine learning model is learned online, with updates arriving asynchronously from clients 200. The server apparatus 200 includes at least a processor 102 and a memory 108, as will be further described herein.

The server apparatus 100 shown in FIG. 1 is connected or otherwise coupled to a server apparatus 104, generally described or herein as a hyper-parameter optimizer or model 104. In one embodiment, the server apparatus 104 can be part of, or included in the server apparatus 100. In alternate embodiment, the server apparatus 104 is a separate device and includes at least a processor 114 and a memory 124. The server apparatus 100 is coupled to client devices 200 through a network 12, such as the Internet, for example.

In one embodiment, if a predefined threshold for received model updates is reached, the server apparatus 100 is configured to transmit a set of current hyper-parameter values and corresponding validation set performance metrics obtained from the updated master machine learning model to the hyper-parameter optimization model of the hyper-parameter optimization server 104. The hyper-parameter optimization model 104 is not part of and is disengaged from the machine model on the server apparatus 100. The aspects of the disclosed embodiments provide for adaptive tuning of the hyper-parameters while the Federated Learning model is being trained and do not rely on the repeated off-line testing of the hyper-parameter configurations, as is typically found in traditional recommendation model. The continuous online tuning provided by the aspects of the disclosed embodiments not only improves the accuracy of recommendations but also helps to achieve faster convergence thereby reducing the computational complexity. Thus, the aspects of the disclosed embodiments also provide an improvement to computer and computing technology by such efficiencies not heretofore realized.

The server apparatus 100 is also configured to receive an updated set of hyper-parameter values from the hyper-parameter optimization model 104 and update the master machine learning model of the server apparatus 100 with this updated set of hyper-parameter values. The updated master machine learning model can then be redistributed to client(s) 200 with the updated set of hyper-parameter values. The aspects of the disclosed embodiments minimize the overhead cost for data transfer, storage and security for the optimization of a machine learning model that is trained on big data inherently distributed across millions of clients 200, such as for example mobile phones or hand held devices. Access to the clients' personal data or models is not required and the aspects of the disclosed embodiments also do not require transferring, storing or securing client's data and local models in central servers. Rather, the only information that is required from the clients 200, without knowing their identities, is the validation set performances, also referred to as accuracy metrics.

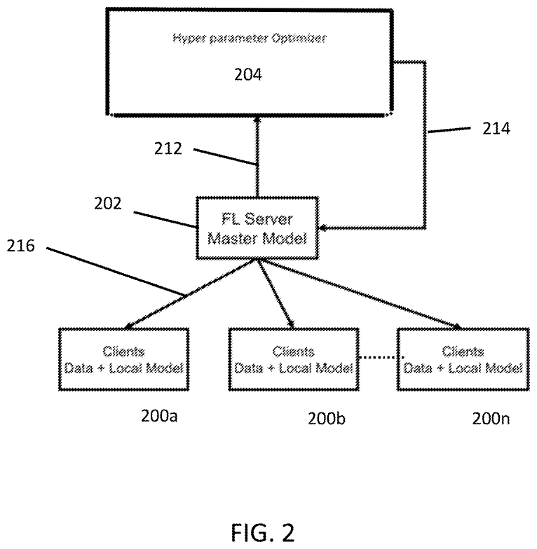

FIG. 2 illustrates one embodiment of a system 20 incorporating aspects of the disclosed embodiments. In this example, a Federated Learning Server 202, also referred to herein as a Federated Learning Server Master Model 202 is connected or coupled to a hyper-parameter optimizer or server 204. While the Federated Learning Server 202 and the hyper-parameter optimizer 204 are shown as separate devices in the example of FIG. 2, the aspects of the disclosed embodiments are not so limited. In alternate embodiments, the server 202 and 204 can comprises a single device or server.

As shown in FIG. 2, the Federated Learning Server 202 includes a Master Model. The Master Model of the Federated Learning Server 202 is not part of and is disengaged from the hyper-parameter optimizer 204. Also, the hyper-parameter optimizer 204 does not have access to the Master Model and the data. This is unlike the traditional hyper-parameter optimizer solution where the master model and data are part of the hyper-parameter optimizer.

In the example of FIG. 2, the hyper-parameter optimizer 204 receives as an input 212 from the Federated Learning Server master model 202, current hyper-parameter configuration and performance metrics. The Federated Learning Server master model 202 collects and stores the current configuration and performance metrics as part of model updates sent by clients. The hyper-parameter optimizer 204 is configured to update the configuration history and learn the optimization model. In one embodiment, the Federated Learning server master model 202 is configured to send 212 the hyper-parameter values and performances to the hyper-parameter optimizer 204 at regular intervals in order to build up the history in the hyper-parameter optimizer 204. In one embodiment, the hyper-parameter optimizer 204 in FIG. 2 maintains a pairwise history of the hyper-parameter values and the corresponding validation set performances obtained from the Federated Learning master model when trained using those values.

The hyper-parameter optimizer 204 uses the historical data (hyper-parameter values-validation set performances) to train an optimization model, such as for example a Bayesian optimization model. Given the current hyper-parameters and performance values as a new input query, the optimization model infers the next set of potentially optimal hyper-parameters for the Federated Learning master model. A new or updated hyper-parameter configuration can be outputted 214 or otherwise transmitted to the Federated Learning Server 202.

The Federated Learning master model 202 is configured to update the current hyper-parameters in the master model with the new values and distribute the updated copy of the master model across one or more of clients 200-a to 200-n. The client data remains private and distributed. As will be understood, the system 20 can include any suitable number of clients 200a-200n. In this manner, the aspects of the disclosed embodiments enable optimizing hyper-parameters in an online, continuously adaptive fashion, while the Master Model of the Federated Learning server 202 continues the training. This is contrary to the traditional approach of hyper-parameter optimization in a Federated Learning system.

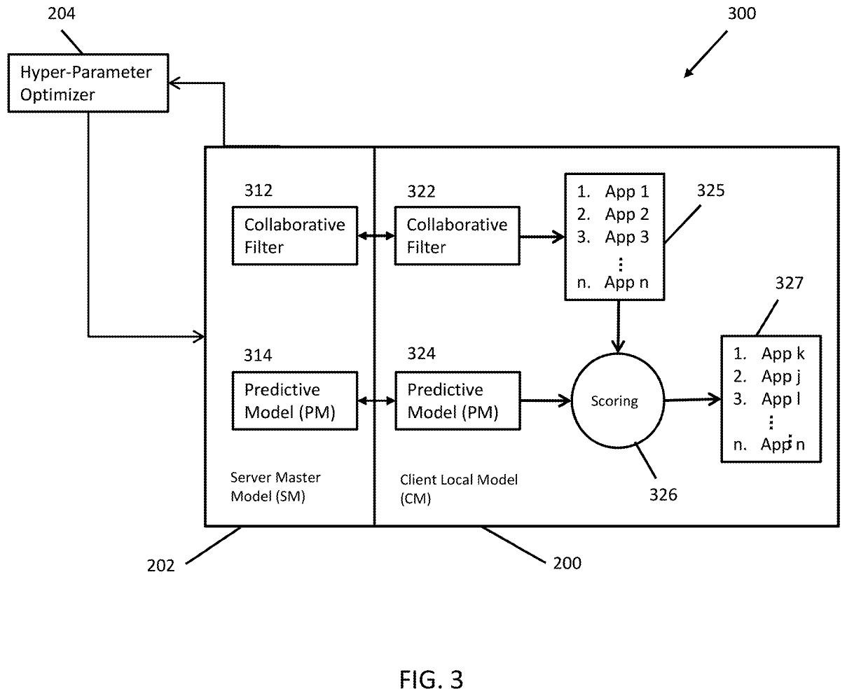

FIG. 3 illustrates an exemplary implementation of the aspects of the disclosed embodiments in a recommendation system 300. In this example, the recommendation system 300 is the Huawei Video Service. The Huawei Video Service 300 generates personalized recommendations for each user of its services on their mobile devices. In this example, the recommendation system 300 includes a server side 202 and a client or client side 200. The client side 200 generally represents a user device, such as a mobile communication device or mobile telephone, for example. As will be understood, the client side 200 will comprise a plurality of user devices, such as the clients 200a-200n referred to in FIG. 2. For the purposes of the description herein only one client on the client side 200 will be described. However, the description herein will generally apply to each client or user device on the client side 200.

The server side 202 of the recommendation system 300 is composed of one or more processors running two algorithms operating in Federated Learning mode. A Collaborative Filter (CF) 312 is used to generate a user specific candidate set of video recommendations. A Predictive Model (PM) 314 is used to score each video in the candidate set and to generate the final video recommendations.

A client on the client side 200, also referred to herein as a client side device or client side devices, is also composed of one or more processors running two algorithms operating in Federated Learning mode. In this example, a Collaborative Filter (CF) 322 on the client side 200 is used to receive and generate a user specific candidate set 325 of video recommendations. A Predictive Model (PM) 324 on the client side 200 is used to score 326 each video in the candidate set and to generate the final set 327 of video recommendations. As applied to the example of FIG. 2, each client 200a-200n on the client side will generate a final set 327 of video recommendations.

The Collaborative Filter 322 generates the candidate set 325 based on a user's video watch event or behavioral data. The Predictive Model 324 re-scores 326 the candidate set 325 based on the user's personal data. In this example, the candidate set 325 is seen as a sub-set of the total number of videos, filtered based on the user's watching behavior. This filtered set is then re-scored 326 such that the videos which have high probability of being liked by the user get a high score and are recommended.

The aspects of the disclosed embodiments can be used to optimize hyper-parameters of the Collaborative Filters 312, 322 and Predictive Models 314, 324. In one embodiment, the Huawei Video Service initializes two hyper-parameter optimizers 204 on its servers one for the Collaborative Filter 312 and one for the Predictive Model 314 respectively. The optimizers 204 suggest preliminary hyper-parameter values for the master models on the server side 302.

Initialization of Validation Set Performance Metrics: Huawei Video Service initializes validation set performance metrics namely Root Mean Squared Error (RMSE) and log-loss on its server 202, one for the Collaborative Filter 312 and one for the Predictive Model 314, respectively. The performance metrics are collected by the clients 200 and are used by the hyper-parameter optimizers 204 to infer the new hyper-parameters.

Initialization Master Models: Huawei Video Service creates two master models on its server 202, one for the Collaborative Filter 312 and one for the Predictive Model 314. The two master models are initialized with the respective hyper-parameters suggested by the hyper-parameter optimizer 204.

Client Side 200: Each of the master models and metrics described above are distributed to each of Huawei Video services user devices on the client side 200 shown in FIG. 3. The master models along with the metrics from the server side 202, referred to as the local master models on the client side 200, now reside on the user devices, such as the user devices 200a-200n shown in FIG. 2, and have the same hyper-parameter configurations as the master models on the servers 202. In one embodiment, the local master models that now reside on the client side 200 are generally configured to generate recommendations, update and train and evaluate.

In one embodiment, the local master model of the collaborative filter 322 is used to generate a candidate set 325 of videos for the user using the local user data. The local user data in this example, can include, but is not limited to, the videos watched by the user on that device. The generated candidate set 325 of videos is scored 326 by the local predictive module 324 based on user personal data. The user personal data can include for example, but is not limited to other applications used by the user, date of birth stored on the user device, location of the device etc.). The result of the scoring 326 is the final list or set 327 of videos, which is generated or provided as a personal set of video recommendations to the user. The locally generated video recommendations can then be shown or otherwise presented to the user on the device. In this manner, the user of a particular client device 200 is encouraged to select one or more of the video recommendations from this personalized set 327 for watching.

The client side 200 can also able to update and train the local master model on the local or user's device, such as device 200n of FIG. 2. Based on the user's viewing of different videos in the Huawei video service, the different videos are randomly divided into training, validation and test sets. Using the training set, the local master model of the respective collaborative filter 322 is updated. As the system 300 will include a number of different client side devices 200, the local master model updates for each user, or client side device 200, are different and independent.

Using the training set and based on the user's personal data, such as for example, the user's uses of other services on the device, the user's age and gender, the local predictive model 324 is updated. Here again, the updates for the different users in the system 300 will be different and independent.

The local master model updates from the collaborative filter 322 and predictive model 324 of the client side device(s) 200 are transferred back to the server side 202. In this example, the server side 202 is the Huawei video service server. Thus, the Huawei video service server will receive and can aggregate, a number of local master model updates, one from each client side device 200 in the recommendation system 300.

On the client side 200, using the local data, the validation set 325 and training set 327 video recommendations are generated for each user independently. The training set 327 is used to update the local model. The validation set 325 is used to evaluate the local model and compute the validation set performance metrics. The validation set recommendations are evaluated to update the validation set performance metrics. The validation set performance metrics updates for the local collaborative filter 322 and predictive model 324 models are transferred back to the Federated Learning Server, or in this example, the Huawei video service server 202, where the Federated Learning Master Model is residing.

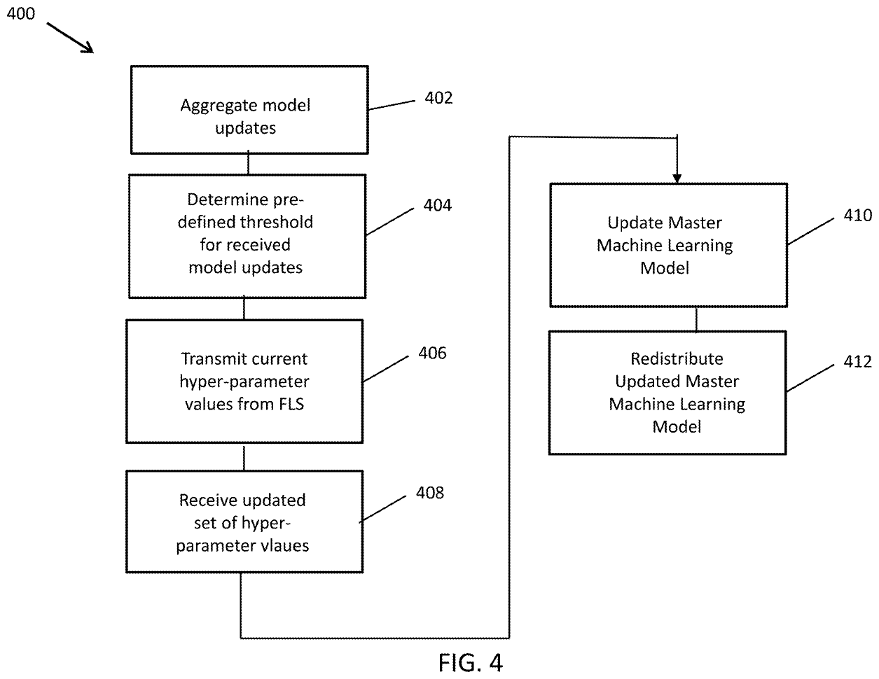

Referring also to FIG. 4, on the server side 202, such as for example the Huawei Video Service, the collaborative filter model updates received from the client side devices 200 are aggregated 402 to update the collaborative filter 312 master model. The collaborative filter validation set performance metric updates received from each client side device 200 are averaged to create a new updated collaborative filter metric, referred to as RMSE. When a pre-defined threshold for collaborative filter model updates is reached 404, or some other suitable interval, the master model of the collaborative filter 312 sends 406 the current hyper-parameters and performance metrics to the optimizer 204 and requests new hyper-parameter values.

In one embodiment, the optimizer 204 is configured to update the history of hyper-parameter configurations or values and the corresponding validation set performance metric, the RMSE value. The optimizer 204 updates the optimization model of the collaborative filter 312 and predicts a new set of hyper-parameter values and sends the new hyper-parameter values back to the master model of the collaborative filter 312.

Once received 408 in the server 202, the master model of the collaborative filter 312 is configured to replace and update 410 the current hyper-parameters of the collaborative filter 312 with the new hyper-parameter configurations or values. The copy of the updated master model for the collaborative filter 312 is redistributed 412 across all clients 200. The updated collaborative filter master model replaces the local master models in the respective collaborative filter 322 of each client 200.

The server 202 is also configured to aggregate the predictive model updates obtained from each client 200 and update the master model of the predictive model 314 of the server 202. The validation set performance metric updates received from each client for the predictive model 324 are averaged to create a new updated predicted model metric, generally referred to herein as log-loss. When a pre-defined threshold or interval for model updates from the different predictive models 324 is reached, the master model of the predictive model 314 sends the current hyper-parameter and performance metrics to the optimizer 204 and requests new values.

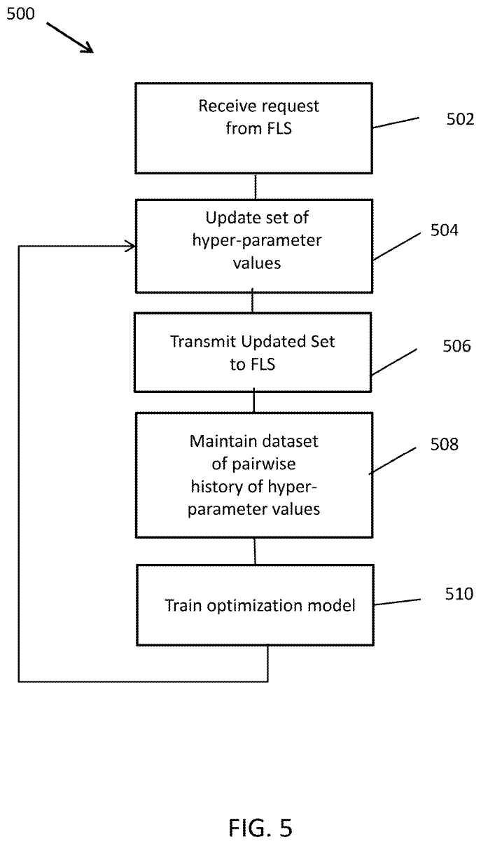

Referring also to FIG. 5, in one embodiment, the optimizer 204 receives 502 the request and is configured to determine and update 504 the history of the hyper-parameter configuration and corresponding validation set performance metric, referred to herein as the log-loss values. The optimizer 204 updates the optimization model of the predictive model 314. The optimizer 204 is configured to predict a new set of hyper-parameter configurations and send 506 the new set of hyper-parameters to the master model of the predictive model 324.

In one embodiment, the optimizer 204 is also configured to maintain 508 a pairwise history of hyper-parameter values. The optimizer 204 can use this pairwise history of hyper-parameter values to train 510 an optimization model. The training of the optimization model can be used to generate the new set of hyper-parameters that will be used to update the master model of the server 202.

The master model of the predictive model 314 replaces the current hyper-parameters with new configurations or values provided by the optimizer 204. The updated master model of the predictive model 314 is redistributed to all clients 200 and replaces the local master models in the predictive model 324 of the respective client 200. From here the process is reiterated.

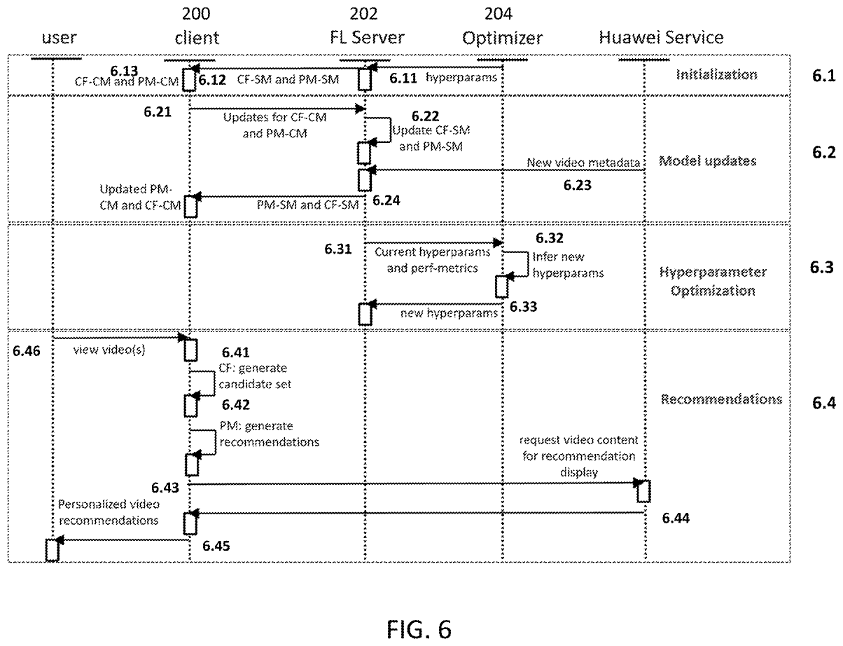

FIG. 6 illustrates, through an exemplary sequence diagram, the process of generating personalized recommendations for a recommendation system, such as the Huawei Video Service. In particular, referring also to FIG. 2, the exemplary sequence diagram of FIG. 6 illustrates the interaction of hyper-parameter optimizer 204 with the Federated Learning server 202 to obtain new hyper-parameter values. The algorithm and underlying optimization model used to infer the optimal set of hyper-parameters is a Bayesian optimization model. One example of such a Bayesian optimization model for presenting a method for hyper-parameter optimization of Federated Machine Learning algorithms is described in the paper entitled “Hyper-parameter optimization of a machine learning model in a Federated Learning approach” authored by Ammad-ud-din et. al., EU Cloud Technology, Helsinki Research Center, Huawei Technologies Co., Inc., the disclosure of which is incorporated herein by reference in its entirety.

Referring to FIG. 6, during an initialization step 6.1, the hyper-parameter optimizer 204 suggests 6.11 preliminary hyper-parameter values for the master models. The hyper parameter optimizer 204 is initialized and configured to maintain the hyper parameter values and corresponding performance metrics.

The Federated Learning Server master model 202 creates two master models on its servers, one for the collaborative filter (CF-SM) and one for the predictive model (PM-SM). The models CF-SM and PM-SM are initialized with the respective hyper-parameters suggested 6.11 by the hyper-parameter optimizer 204. Copies of the master models CF-SM and PM-SM are distributed 6.12 to the user devices or clients 200. The copies 6.13 of the master models CF-SM and PM-SM, along with the metrics, now reside on the user devices 200, now referred to as the local master models CF-CM and PM-CM, and have the same hyper-parameter configurations as the master models CF-SM and PM-SM on the servers 202.

The next phase or step includes the model updates 6.2. The client 200 sends 6.21 local model updates CF-CM and PM-CM to the Federated Server master model 202. The master model, including the CF-SM and PM-SM, is updated using the local model updates received from the client 200. If, for example at this point, if a new video is added to the collection, the master model is configured to take into account the meta-data 6.23 of the new video. The updated master model CF-SM and PM-SM is distributed 6.24 to the clients 200.

In one embodiment, in a hyper-parameter optimization step 6.3, if a predefined threshold of model updates has been reached, the Federated Learning server 202 sends 6.31 the current hyper-parameter values and corresponding performance metrics to the hyper-parameter optimizer 204. The hyper-parameter optimizer 204 is configured to infer 6.32 a new set of hyper-parameters values. The hyper-parameter optimizer 204 is then configured to send 6.33 the new hyper-parameter values to the Federated Learning server 202.

In a recommendation stage 6.4, the personalized video recommendations are shown to the user by generating 6.41 a candidate set using the collaborative filter and rescoring 6.42 the candidate set with the predictive model. To display 6.45 the recommended video to the user, the client device 200 requests 6.43 the video content from the Huawei video service. Information regarding the viewing 6.46 of a recommended video is recorded by the client device 200.

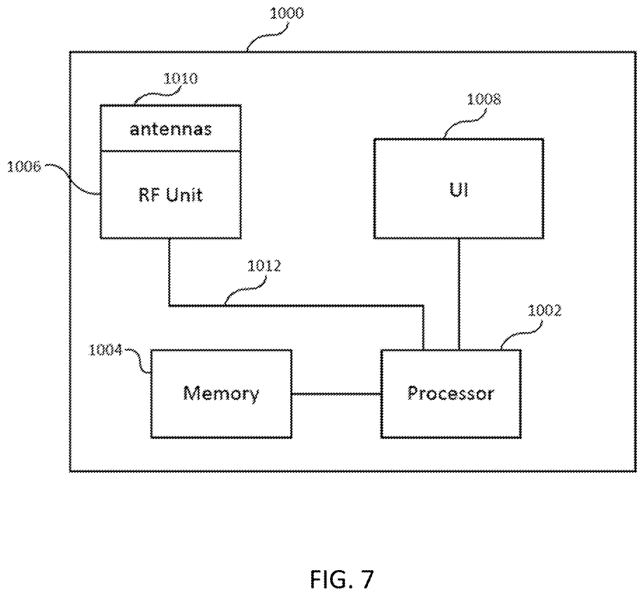

FIG. 7 illustrates a block diagram of an exemplary apparatus 1000 appropriate for implementing aspects of the disclosed embodiments. The apparatus 1000 is appropriate for use in a wireless network and can be implemented in one or more of the user equipment apparatus 100 or the backend server apparatus 200.

The apparatus 1000 includes or is coupled to a processor or computing hardware 1002, a memory 1004, a radio frequency (RF) unit 1006 and a user interface (UI) 1008. In certain embodiments such as for an access node or base station, the UI 1008 may be removed from the apparatus 1000. When the UI 1008 is removed the apparatus 1000 may be administered remotely or locally through a wireless or wired network connection (not shown).

The processor 1002 may be a single processing device or may comprise a plurality of processing devices including special purpose devices, such as for example, digital signal processing (DSP) devices, microprocessors, graphics processing units (GPU), specialized processing devices, or general purpose computer processing unit (CPU). The processor 1002 often includes a CPU working in tandem with a DSP to handle signal processing tasks. The processor 1002, which can be implemented as one or more of the processors 102, 114 and 202 described with respect to FIG. 1, may be configured to implement any one or more of the methods and processes described herein.

In the example of FIG. 10, the processor 1002 is configured to be coupled to a memory 1004 which may be a combination of various types of volatile and non-volatile computer memory such as for example read only memory (ROM), random access memory (RAM), magnetic or optical disk, or other types of computer memory. The memory 1004 is configured to store computer program instructions that may be accessed and executed by the processor 1002 to cause the processor 1002 to perform a variety of desirable computer implemented processes or methods such as the methods as described herein. The memory 1004 may be implemented as one or more of the memory devices 108, 124, 208 described with respect to FIG. 1.

The program instructions stored in memory 1004 are organized as sets or groups of program instructions referred to in the industry with various terms such as programs, software components, software modules, units, etc. Each module may include a set of functionality designed to support a certain purpose. For example a software module may be of a recognized type such as a hypervisor, a virtual execution environment, an operating system, an application, a device driver, or other conventionally recognized type of software component. Also included in the memory 1004 are program data and data files which may be stored and processed by the processor 1002 while executing a set of computer program instructions.

The apparatus 1000 can also include or be coupled to an RF Unit 1006 such as a transceiver, coupled to the processor 1002 that is configured to transmit and receive RF signals based on digital data 1012 exchanged with the processor 1002 and may be configured to transmit and receive radio signals with other nodes in a wireless network. In certain embodiments, the RF Unit 1006 includes receivers capable of receiving and interpreting messages sent from satellites in the global positioning system (GPS) and work together with information received from other transmitters to obtain positioning information pertaining to the location of the computing device 1000. To facilitate transmitting and receiving RF signals the RF unit 1006 includes an antenna unit 1010 which in certain embodiments may include a plurality of antenna elements. The multiple antennas 1010 may be configured to support transmitting and receiving MIMO signals as may be used for beamforming.

The UI 1008 may include one or more user interface elements such as a touch screen, keypad, buttons, voice command processor, as well as other elements adapted for exchanging information with a user. The UI 1008 may also include a display unit configured to display a variety of information appropriate for a computing device or mobile user equipment and may be implemented using any appropriate display type such as for example organic light emitting diodes (OLED), liquid crystal display (LCD), as well as less complex elements such as LEDs or indicator lamps.

The aspects of the disclosed embodiments are directed to a method and system to perform a hyper-parameter optimization for a federated machine learning system. Personalized recommendation through, for example, the Huawei video service is a machine learning problem and requires data, machine learning model and hyper-parameter optimization, to further improve upon the accuracy of recommendations.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A server apparatus comprising:
a processor; and
a memory having processor-executable instructions stored thereon, which when executed by the processor, case the server apparatus to:
aggregate a plurality of received model updates to update a master machine learning model;
determine whether a pre-defined threshold for received model updates is reached;
transmit a set of current hyper-parameter values and corresponding validation set performance metrics obtained from the updated master machine learning model to a hyper-parameter optimization model;
receive an updated set of hyper-parameter values from the hyper-parameter optimization model;
update the master machine learning model with the updated set of hyper-parameter values; and
redistribute the updated master machine learning model with the updated set of hyper-parameter values.

2. The server apparatus according to claim 1, wherein the processor is configured to periodically request an updated set of hyper-parameter values from the hyper-parameter optimization model.

3. The server apparatus according to claim 1, wherein the master machine learning model operates in a Federated Learning System.

4. The server apparatus according to claim 1, wherein the master machine learning model is one or more of a Federated Learning Collaborative Filter model or a Federated Learning Logistic Regression Model.

5. A server apparatus comprising:
a processor; and
a memory having processor-executable instructions stored thereon, which when executed by the processor, case the server apparatus to:
receive a set of current hyper-parameter values for a master machine learning model and corresponding validation set performance metrics from a federated learning server;
determine an updated set of hyper-parameter values for the master machine learning model from the received set of hyper-parameter values and the corresponding validation set performance metrics; and
send the updated set of hyper-parameter values for the master machine learning model to the federated learning server.

6. The server apparatus according to claim 5, wherein the processor is configured to cause the server apparatus to maintain a pairwise history of received hyper-parameter values and the corresponding validation set performance metrics obtained from the master machine learning model on the federated learning server.

7. The server apparatus according to claim 5, wherein the processor is configured to train an optimization model using an accumulated history of hyper-parameter values and the corresponding validation set performance metrics.

8. The server apparatus according to claim 7, wherein the processor is configured to cause the trained optimization model to infer the updated set of hyper-parameter values for the master machine learning model from the received hyper-parameter values and the corresponding validation set performance metrics.

9. A method applied to a server apparatus, the method comprising:
aggregating a plurality of received model updates to update a master machine learning model;
determining whether a pre-defined threshold for received model updates is reached;
transmitting a set of current hyper-parameter values and corresponding validation set performance metrics obtained from the updated master machine learning model to a hyper-parameter optimization model;
receiving an updated set of hyper-parameter values from the hyper-parameter optimization model;
updating the master machine learning model with the updated set of hyper-parameter values; and
redistributing the updated master machine learning model with the updated set of hyper-parameter values to a plurality of clients.

10. The method according to claim 9, further comprising periodically requesting an updated set of hyper-parameter values from the hyper-parameter optimization model.
